(19) United States
(12) Patent Application Publication
(10) Pub. No.: US 2007/0080006 A1
(43) Pub. Date: Apr. 12, 2007

(54) Hybrid vehicle

(76) Inventor: Koichi Yamaguchi, Tokyo (JP)

Correspondence Address: SMITH, GAMBRELL & RUSSELL, 1850 M STREET, N.W., SUITE 800, WASHINGTON, DC, 20036, US

(21) Appl. No.: 10/577,229

(22) PCT Filed: Nov. 10, 2004
(86) PCT No.: PCT/JP04/16645

§ 371 Date: Apr. 26, 2006

(30) Foreign Application Priority Data
Nov. 10, 2003 (JP) 2003-380123

(51) Int. Cl. B60L 8/00

(52) U.S. Cl. 180/65.3

(57) ABSTRACT

A hybrid vehicle capable of avoiding that a driver declares that a battery is defective when a battery for auxiliary traveling does not yet require maintenance. When the charged amount of the battery is lower than a specified value, operating conditions for idle/stop control are changed without any optical display such as indications by lamp so that the idle/stop control is not performed frequently.

### TECHNICAL FIELD

The present invention is used in a hybrid vehicle running on a combination of electric power supplied by a motor generator and mechanical power supplied by an internal combustion engine. The present invention relates to a device that monitors the state of charge of a battery installed in a hybrid vehicle and used as an energy source supplying electric power. In particular, it relates to an improvement in means used to alert the driver when the state of charge of the battery deteriorates for any reason.

Although the present invention is a device developed for use in a hybrid vehicle of the type wherein a single rotary machine (motor generator) is installed in a vehicle and switching control is carried out to enable its use either as an electric motor or as a generator, it can be implemented in the same way in a hybrid vehicle of the type in which an electric motor and a generator are provided as separate devices.

### BACKGROUND ART

Batteries installed in hybrid vehicles as a source of electric power are relatively large in size. This is due to the fact that they are used not only for starting the internal combustion engine or supplying electric power to lamps and other electrical equipment installed in a vehicle, but also used as a power source for supplying electrical energy used for driving the vehicle. In case of a hybrid vehicle, coupling the rotational power of the axle to the rotating shaft of the generator allows for electrical energy to be generated when the vehicle is braked and stored in the battery installed in the vehicle. Subsequently, when the vehicle starts moving, or when the vehicle is driven under acceleration, the electrical energy stored in the battery is supplied to the electric motor, thereby allowing for more economical fuel consumption by the internal combustion engine. The effects are not limited to achieving more economical fuel consumption and can also reduce the output load of the internal combustion engine during vehicle startup, acceleration, or during grade-climbing, etc., which makes it possible to reduce the amount of harmful emissions generated by the internal combustion engine. This is known to be extremely effective in creating a cleaner environment.

The large-size battery installed in a hybrid vehicle is a secondary battery that can be charged and discharged. When energy used for travel is supplied by such a battery, control is effected differently depending on its charge. In other words, when the charge of the battery is large, control can be performed in such a way that the proportion of auxiliary acceleration provided by electric power during vehicle startup and grade-climbing, etc. can be increased. When the charge of the battery becomes smaller, control is effected such that the proportion of the auxiliary acceleration provided by electric power is reduced, or such auxiliary acceleration provided by electric power is prohibited altogether. Moreover, when the charge of the battery becomes smaller, control can be effected such that the battery is charged by driving the generator in rotation using the internal combustion engine when the vehicle is stopped. Additionally, when the charge/discharge performance of a large battery installed in a hybrid vehicle degrades, the battery has to be replaced or maintenance has to be performed, such as replacing or cleaning the electrolyte and the electrodes.

A conventional hybrid vehicle is adapted to detect a decline in the charge/discharge performance of such a large-capacity travel drive battery and provide driver-side lamp indication or other optical indication reminding of battery maintenance and repair. There are various well-known techniques used to detect a decline in charge/discharge performance. Such well-known techniques include simple ones, including monitoring the terminal voltage of the battery, and others, such as monitoring the terminal voltage of the battery in conjunction with the load of the battery, monitoring the terminal voltage in conjunction with the discharge current of the battery, or monitoring the temperature of the electrolyte in the battery in conjunction with the terminal voltage or electric current, etc. Some of these techniques are illustrated in the following patent documents.

On the other hand, a technology has been known in the past, in which vehicles equipped with an internal combustion engine are provided with idling stop means. It is adapted to automatically stop the rotation of the internal combustion engine upon lapse of a preset period of time when the internal combustion engine of a vehicle is in a low-load operation mode (idling operation mode). If the engine is automatically stopped by the idling stop means, the internal combustion engine is restarted when the starter motor is automatically started by operations such as depressing the clutch pedal, shifting the gearshift, depressing the accelerator pedal, etc. Such idling stop means makes a considerable contribution to creating a cleaner environment and achieving more economical fuel consumption by increasing the efficiency of vehicles traveling on congested roadways, buses picking up and discharging passengers, etc.

The idling stop means can be implemented in hybrid vehicles in a similar way. In a hybrid vehicle constructed by coupling the rotating shaft of the generator directly to the internal combustion engine, the rotation of the internal combustion engine can be stopped if the state of charge of the battery is judged to be good in accordance with predetermined requirements. Moreover, in a hybrid vehicle of the type, in which an axle-driving electric motor is provided separately from a generator coupled to an internal combustion engine, when the charge of the battery is not less than predetermined value, control is effected such that the internal combustion engine is stopped and no battery charging is performed even when the vehicle is standing still or when the vehicle is traveling at a low electric motor load.

Below, the electric motor and generator are called “motor generator” without making a distinction between the two.

[Patent Document 1] JP2000-348780 A

[Patent Document 2] JP H11-121048 A

[Patent Document 3] JP H8-336202 A

[Patent Document 4] JP 2936454 B

[Patent Document 5] JP H4-183203 A

[Patent Document 6] JP H6-261411 A

### DISCLOSURE OF INVENTION

### PROBLEM TO BE SOLVED BY THE INVENTION

The control system of a hybrid vehicle is typically equipped with a monitoring circuit that monitors the state of charge of the battery in one way or another. Arrangements, in which lamps are lit and other optical indication is provided on the driver's side when the state of charge of the battery detected by the monitoring circuit deteriorates beyond a predetermined level, are widely used in hybrid vehicles. Incidentally, based on the results of actual usage and various experiments, experience shows that in such arrangements the driver tends to recognize battery problems sooner than later.

Namely, problems related to a decline in battery rechargeability rarely arise all of a sudden and in most practical cases the decline in rechargeability takes place little by little, with the magnitude of the problem growing in a gradual manner. Generally speaking, because the degradation of the battery is caused mostly by a decrease in the chemical activity of the battery, its rechargeability almost never declines rapidly. Furthermore, because the battery of a hybrid vehicle is used for repeated charging and discharging operations depending on the driving conditions, even if the battery gets discharged, its performance is restored when it is automatically charged during travel. When the battery starts to degrade, at the very beginning, the lamp on the driver's side is repeatedly turned on and off to alert the driver to the state of charge and, if the battery continues to be used, the lamp on the driver's side starts glowing steadily for an extended period of time.

When the battery starts to degrade and such a procedure begins, the driver (or the owner of the vehicle) recognizes that there is something wrong with the battery and requests maintenance and repairs when the lamp on the driver's side starts blinking. As a result, checkups performed on drivers' request used to repeatedly show that there was nothing wrong, that there were no problems in the charging system, and that there was no need for maintenance.

As mentioned above, the rechargeability of the battery decreases only very gradually, and even though alerts may be temporarily generated during charge and discharge cycling in the process of driving the vehicle, they are not of an urgent nature requiring immediate attention. Even if a decline in the rechargeability of the battery does take place, in the initial stage, it creates no impediment to driving the vehicle. The vehicle won't break down on the road and won't be rendered inoperable because of a decline in the rechargeability of the battery. However, it is necessary to alert the driver to the decrease in the rechargeability of the battery in one way or another.

The present invention addresses such circumstances and it is an object of the present invention to provide a device, instead of driver-side lamp indication used for warning of degradation in the rechargeability of the battery, that allows drivers to recognize it in a more expedient manner. It is an object of the present invention to provide a display technique that, when the degradation in the state of charge of the battery starts, allows the driver to notice problems and request vehicle maintenance after the problems develop to the appropriate extent. It is an object of the present invention to provide a device that alerts the driver to the state of charge of the battery while allowing the driver to recognize it in a measured manner.

### MEANS FOR SOLVING PROBLEM

The principal characteristic of the present invention consists in performing control so as to modify the conditions of idling stop control when problems are detected by the means used for monitoring the state of charge of the battery. As explained above, the term “idling stop control” refers to control, whereby the internal combustion engine is automatically stopped in the abscence of special operations performed by the driver when the vehicle comes to a stop. Namely, when the state of charge of the battery is normal and when the vehicle comes to a stop and the load of the internal combustion engine becomes smaller than a predetermined value and this state continues for a predetermined time, idling stop control is activated automatically and the internal combustion engine is stopped. When problems are detected in the state of charge of the battery, the device of the present invention does not use idling stop control or performs control so as to modify the conditions used for executing idling stop control such that idling stops are not performed frequently. While in and of themselves the state of charge of the battery of a hybrid vehicle and idling stop control are not directly related phenomena, the invention links them in the above manner and substitutes them for displaying irregularities in the state of charge of the battery.

In this arrangement, the driver does not directly recognize the presence of irregularities in the state of charge of the battery, but instead recognizes that idling stop control is performed less frequently. The execution of idling stop control does not rely on operations performed by the driver. Namely, the invention is adapted to effect idling stop control automatically and start the internal combustion engine automatically whenever the driver wants to get the car moving and depresses the clutch pedal, shifts the gearshift, etc. Therefore, even though idling stop operation becomes somewhat sluggish, it does not create any particular inconvenience for the driver and does not require immediate maintenance. As a result of gradual changes in the state of charge of the battery, the execution of idling stop control becomes uneven, but the driver does not immediately recognize this as an abnormal condition.

Furthermore, when the rechargeability of the battery degrades, performing control so as to prevent the execution of idling stops is sometimes desirable from the standpoint of idling stop control. Namely, in arrangements, in which batteries used for hybrid vehicles are utilized for starting the internal combustion engine, electric current for restarting the internal combustion engine in the process of idling stop control is obtained from a battery whose degradation has already begun; in the arrangement of the present invention, however, the frequency of such use is controlled to make it less frequent, which prevents it from further aggravating the degradation in the state of charge of the battery. However, when the starting battery used for the internal combustion engine is separate from the hybrid vehicle battery, these are unrelated phenomena.

Namely, the present invention is characterized in that, in a hybrid vehicle comprising an internal combustion engine, a motor generator, a battery, an inverter electrically coupling the battery and the motor generator, a control circuit controlling the inverter, and state-of-charge monitoring means for monitoring the state of charge of the battery, and, furthermore, the internal combustion engine comprising idling stop means which automatically stops the rotation of the internal combustion engine under the conditions of operation that the load of the internal combustion engine drops and continuously stays below a preset value for a predetermined time, there is provided means for modifying the conditions of operation of the idling stop means when the state-of-charge monitoring means detects that the state of charge of the battery has fallen below preset conditions without additionally providing an optical display of insufficient state of charge on the driver's side.

Here, the language “without additionally providing an optical display of insufficient state of charge on the driver's side”, as described above, does not mean that any optical display of insufficient state of charge on the driver's side is excluded. Additional optical display of insufficient state of charge on the driver's side may be provided when the degradation of the battery develops even further. The present invention can be reduced to practice by adopting an arrangement, in which an optical display of insufficient state of charge is provided on the driver's side, the conditions of operation of the idling stop means are modified as the degree of degradation of the battery increases, and optical display is carried out when the degradation develops even further.

An arrangement can be used, in which the means used for modifying the conditions of operation of the idling stop means comprises means for prohibiting idling stop operation. Also, an arrangement can be used, in which the means used for modifying the conditions of operation of the idling stop means comprises means for changing the predetermined time (t₀) to a larger value (t₁>t₀). Furthermore, an arrangement can be used, in which the means used for modifying the conditions of operation of the idling stop means comprises means for changing the preset load value (L₀) to a smaller value (L₁<L₀).

### EFFECTS OF THE INVENTION

The present invention reduces the frequency of maintenance requests from drivers who needlessly react to the initial stages of degradation in the rechargeability of large-capacity batteries installed in hybrid vehicles.

### BRIEF DESCRIPTION OF DRAWINGS

FIG. 1 shows a block diagram of a working example of the device of the present invention.

FIG. 2 shows a diagram explaining the control operations performed in a working example of the inventive device according to the state of charge of the battery.

FIG. 3 shows the main portion of a control flow chart of the idling stop means used in the working example of the present invention.

### DESCRIPTION OF REFERENCE NUMERALS

1. Internal combustion engine

2. Motor generator

3. Clutch

4. Transmission

5. Drive shaft

6. Inverter

7. Control circuit

8. Battery

### BEST MODE FOR CARRYING OUT THE INVENTION

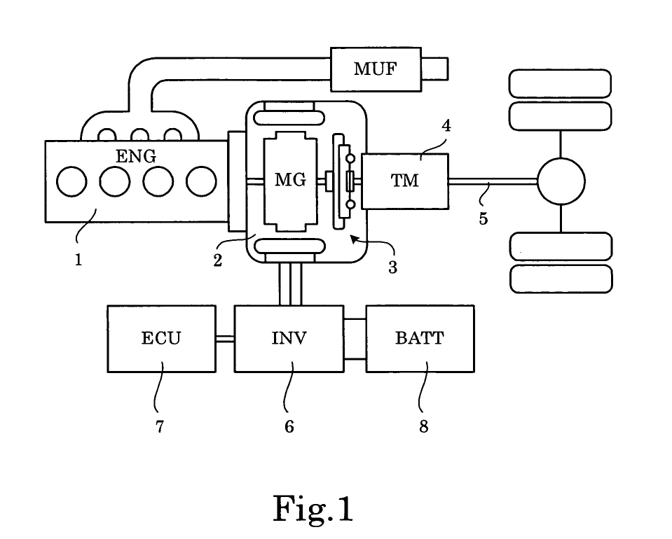

A working example of the device of the present invention will be now explained by referring to drawings. FIG. 1 is a block diagram of a working example of the device of the present invention. The device used in the working example is a hybrid vehicle obtained by installing a hybrid engine in a four-wheel medium-sized freight vehicle.

First of all, a brief explanation will be provided with regard to the construction of the hybrid vehicle, in which a motor generator 2 is fixedly coupled to the output shaft of an internal combustion engine 1. A clutch 3 is coupled to an output shaft of the motor generator 2, and an output shaft of the clutch 3 is coupled to an input shaft of the transmission 4. The output shaft of the transmission 4 is used as a drive shaft 5.

The clutch 3 is controlled by a clutch control unit, not shown, to be engaged or disengaged, including half-clutch operation. The transmission 4 is a mechanical device including six forward speeds and reverse gears. A transmission control unit, not shown, controls the switching of the transmission. The clutch control unit and transmission control unit are controlled by a clutch control circuit and a transmission control circuit, respectively, which are constituted by program control circuits. Information on the rotation of the internal combustion engine 1, information on the speed of the vehicle, and information obtained from the gearshift and other actuators provided on the driver's side is inputted into the clutch control circuit and transmission control circuit through an interface.

The inverter 6 is a device used for conversion between three-phase alternating current and direct current. This is a stationary device whose main component is made up of a semiconductor device. The battery 8 is connected to its direct current terminals and the field winding of the motor generator 2 is connected its alternating current terminals. The phase rotation speed of the alternating current terminals is controlled by a control circuit 7. The control circuit 7 is a program control circuit. The control circuit 7 is adapted to have its information signals coupled to the clutch control circuit, the transmission control circuit, and the control circuit of the internal combustion engine, etc. through a control bus, which permits sharing of information on the operation of the internal combustion engine 1, information on the engagement of the clutch, information on the settings of the transmission 4, and information on the operation of the accelerator pedal, etc.

Now, a brief explanation will be provided with regard to the operation of the hybrid vehicle, wherein control is effected such that a rotating magnetic field whose rotational speed is higher than the rotational speed of the armature is generated in the field winding of the motor generator 2 during high-load vehicle operation, such as during vehicle startup, grade climbing, or acceleration and the like. The control circuit 7 achieves that by controlling the alternate phase of the inverter 6. As a result, the motor generator 2 operates as a motor and uses the electric energy supplied from the battery 8 to impart auxiliary acceleration to the rotating shaft of the internal combustion engine 1, i.e. the axle. This is called “assisted drive mode”.

When the vehicle slows down, or when it goes downhill, it is controlled to perform regenerative braking. Namely, in case of the so-called engine braking, during which, at an appropriate vehicle speed, the acceleration pedal is released (or almost released), and the internal combustion engine 1 is driven by the rotation of the drive shaft 5 with acceleration, control is effected so as to operate the motor generator 2 as a generator and perform auxiliary braking. At such time, alternating current that is phase-controlled to produce a rotating magnetic field whose rotational speed is lower than the rotational speed of the armature is supplied to the field winding of the motor generator 2. As a result, some of the mechanical rotational energy supplied by the drive shaft 5 is converted to electrical energy, converted to direct current by the inverter 6, and used to charge the battery 8. This is called “regenerative braking mode”.

Furthermore, when the vehicle comes to a stop and the charge of the battery 8 drops to a predetermined value or smaller, the transmission 4 is shifted to neutral, the motor generator 2 is controlled as a generator, and the motor generator 2 is driven in rotation by the internal combustion engine 1. As a result, when the vehicle comes to a stop, electricity can be produced to charge the battery 8. This is called “stand-still generation mode”.

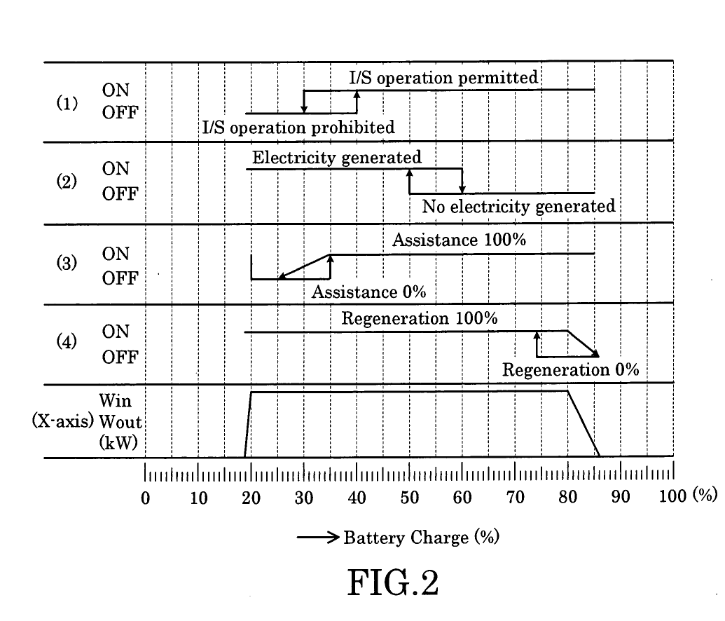

In the thus constructed hybrid vehicle, the device executes various types of control depending on the charge of the battery. This is explained with reference to FIG. 2. FIG. 2 explains how each device operates depending on the charge of the battery. The charge of the battery 8 (SOC, unit: kAH) is expressed as a percentage (%) of the maximum charge along the horizontal axis. The operation of each device is plotted along the vertical axis. Explanations will be provided starting from the lowest and up to the highest section of FIG. 2.

FIG. 2 (5) represents the working range of the battery. In the interval between 20% and 80% charge, charging or discharging can be performed at the allowable maximum power (unit: kW) per unit time. Control is effected such that when the charge is 80% or more, there is a linear decline in the allowable maximum power, and when the charge is 86%, the allowable maximum power turns to zero.

FIG. 2 (4) represents the operating range of the regenerative braking mode. Control is effected such that it is effective when the charge is 80% or less. When the charge exceeds 80%, there is a linear decline until it reaches 86%, and when it exceeds 86%, regenerative braking is prohibited.

FIG. 2 (3) represents the operating range of the assisted drive mode. When the charge of the battery is large, 100% assisted driving is performed; when it is between 35% and 25%, the amount of assistance is gradually reduced, and when it is 25% or less, assisted driving is prohibited.

FIG. 2 (2) represents the operating range of the generation mode. When the charge of the battery is 50% or less, generation mode is used and auxiliary battery charging is performed when the vehicle is standing still. When the battery is charged in the generation mode and its charge exceeds 60%, the generation mode is terminated.

The operation illustrated in FIG. 2 (1) is characteristic of the present invention. It explains the operation involved in idling stop control. Idling stop control consists in performing control such that when the vehicle comes to a stop and the load decreases, the internal combustion engine 1 automatically stops running upon lapse of a predetermined time t (for instance, 2-5 seconds) in the absence of any operations performed by the driver. Then, provided that the driver performs operations such as depressing the accelerator pedal, shifting the gearshift into a forward position, depressing the clutch pedal (in case there is a clutch pedal), etc., control is effected such that even if the driver does not turn the starting switch on, the internal combustion engine 1 is started automatically by rotating the motor generator 2. Such control is effected in order to prevent needless operation of the internal combustion engine 1, fuel consumption or exhaust gas release while the vehicle is standing still.

The device of the present invention is characterized by being adapted to effect such control in accordance with the charge of the battery 8. Namely, when the charge of the battery drops to 30% or less, control that directs the internal combustion engine to automatically stop running while the vehicle is standing still, in other words, the operation of the idling stop means, is prohibited. When the charge of the battery is restored to 40%, the prohibition is removed, and the idling stop means reverts to an effective state.

In the device of the present invention, control is effected in this manner and, at the same time, no optical indication on the driver's side is used to alert the driver to degradation in the state of charge of the battery 8. Namely, the device of the present invention is adapted to alert the driver to degradation in the state of charge of the battery 8 not by relying on lamp indication or other optical indication, but by drawing attention to the fact that the idling stop means no longer works properly.

As described above, this arrangement makes it possible to prevent the driver from reporting degradation of the battery 8 when the degradation of the battery 8 has started recently and there is no need for maintenance and repairs. Namely, the degradation of the battery does not takes place suddenly and at once, but instead develops gradually and slowly in the course of repeated charging and discharging operations, as a result of which it is impossible to accurately recognize it using lamps and other optical indication. When the lamp starts to blink, many drivers decide that the battery has degraded. By contrast, in the arrangement of the present invention, an excessive reaction on the part of the driver can be avoided because the driver is made aware of the degradation of the battery through the fact that the operation of the idling stop means has become more sluggish. Drivers may actually report that “Idling stop control appears to have stopped working properly in this car lately”. At such time, repair personnel can give the battery a checkup.

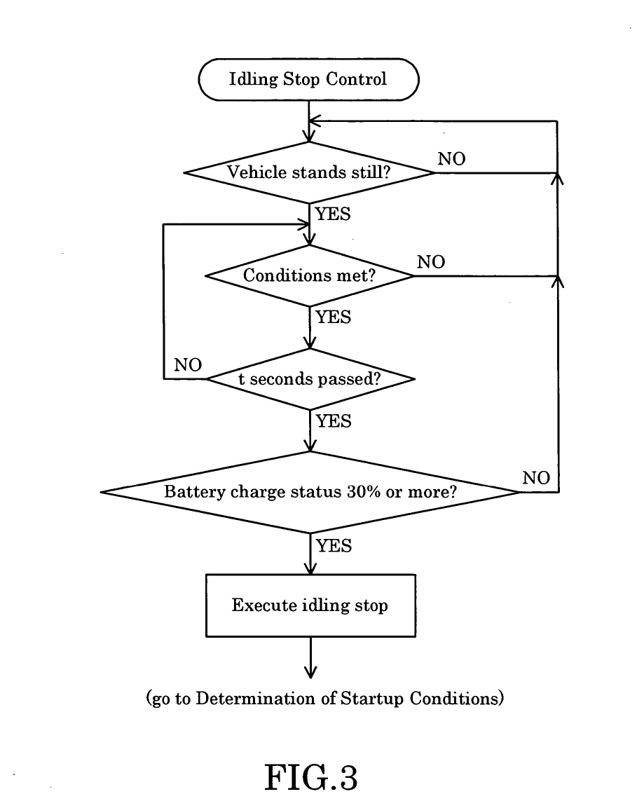

FIG. 3 is the main portion of a control flow chart used in a working example of the device of the present invention. Namely, the idling stop means is installed in the control circuit 7 in software form. The idling stop means is then executed whenever the vehicle comes to a stop with the internal combustion engine running at idle. Explanations are omitted here because the operation can be understood by following the flow of FIG. 3.

### INDUSTRIAL APPLICABILITY

The explanations above described a hybrid vehicle of the construction, in which the rotary machine is a single motor generator, with the motor generator directly coupled to the rotating shaft of the internal combustion engine, but the construction of the present invention can be reduced to practice in hybrid vehicles of any construction. In addition, the same effects can be expected in a hybrid vehicle of any construction.

1. A hybrid vehicle comprising an internal combustion engine, a motor generator, a battery, an inverter electrically coupling the battery and the motor generator, a control circuit controlling the inverter, and state-of-charge monitoring means for monitoring the state of charge of the battery, and, furthermore, the internal combustion engine comprising idling stop means which automatically stops the rotation of the internal combustion engine under the conditions of operation that the load of the internal combustion engine drops and continuously stays below a preset value for a predetermined time, wherein
there is provided means for modifying the conditions of operation of the idling stop means when the state-of-charge monitoring means detects that the state of charge of the battery has fallen below preset conditions without additionally providing an optical display of insufficient state of charge on the driver's side.

2. The hybrid vehicle according to claim 1, wherein the means used for modifying the conditions of operation of the idling stop means comprises means for prohibiting idling stop operation.

3. The hybrid vehicle according to claim 1, wherein the means used for modifying the conditions of operation of the idling stop means comprises means for changing the predetermined time (t₀) to a larger value (t₁>t₀).

4. The hybrid vehicle according to claim 1, wherein the means used for modifying the conditions of operation of the idling stop means comprises means for changing the preset load value (L₀) to a smaller value (L₁<L₀).
